(19) United States
(12) Patent Application Publication
(10) Pub. No.: US 2011/0145190 A1
(43) Pub. Date: Jun. 16, 2011

(54) PUBLIC INSPECTION SYSTEM AND METHOD FOR FCC LICENSED MEDIA OUTLET

(76) Inventors: William V. Barney, Tulsa, OK (US); Nestor L. Custodio, Tulsa, OK (US); Stephen G. Davis, Coweta, OK (US)

(21) Appl. No.: 12/635,616

(22) Filed: Dec. 10, 2009

(51) Int. Cl. G06F 17/30; G06F 15/16

(52) U.S. Cl. 707/622; 707/827; 707/689; 707/783; 709/206; 707/E17.01; 707/E17.005; 709/219

(57) ABSTRACT

A kiosk system facilitates compliance with FCC-mandated Public File requirements for licensed media outlets such as radio and television stations. The system intelligently routes Public File documents to the appropriate field entity (kiosk) without human intervention. These documents are categorized, tagged and made available to the public satisfying the federal requirements. The kiosks can operate in an offline mode with a synchronization system from the parent server to update the kiosks with documents and system data. An alerting system can generate push-email reminders and notifications for key media outlet staff. Additionally, the present invention can provide a virtual workstation kiosk to embed into a media outlet's public-facing websites, providing virtual kiosk access to remote members of the public.

### CROSS-REFERENCE TO RELATED APPLICATION

This application claims priority from U.S. Provisional Patent Application No. 61/196,633 filed Dec. 11, 2008, which is hereby incorporated.

### BACKGROUND OF THE INVENTION

1. Field of the Invention

The present invention generally relates to information technology, and more particularly to a method and system for making information available for public inspection in the context of media outlets regulated by the Federal Communications Commission (FCC) such as broadcast radio and television stations, along with a means of centrally auditing and validating such information to confirm that the information meets the requirements established by the FCC.

2. Description of the Related Art

From the inception of federal licensing of Radio Broadcasting in 1934, the FCC has regulated federally-licensed broadcast media outlets. As a requirement to maintain a license, the FCC's rules mandate that all broadcast stations and applicants for new stations retain a file with certain station information available for public inspection. These rules are located in title 47 of the Code of Federal Regulations (C.F.R.) §§73.3526 (commercial broadcast services) and 73.3527 (noncommercial educational broadcast services).

The rules specifically state that the public inspection file must be maintained at the “main studio” of the station. An applicant for a new station or change of community must maintain its file at any accessible place in the proposed community of license or at its proposed main studio. In the broadcast industry, this information is referred to as the “Public Inspection File” or “Public File,” and must be made available for public inspection at any time during regular business hours. The public must also have the ability to obtain copies of materials at a reasonable cost.

The process of creating and maintaining the Public File, and making it available to the public, is laborious and cumbersome. Indeed, many broadcasting media outlets fall short in their legal duties. The required content is extensive and detailed. For example, each station's Public File must have a copy of the current FCC authorization to operate the station including any documents relating to modifications or conditions on the authorization. The Public File must further have a copy of the application tendered for filing with the FCC together with all supporting documentation. Other required information includes contour maps, ownership reports, political broadcasts, Equal Employment Opportunity file, a specific educational publication, issues/programs lists, donor lists, local public notice announcements, “must-carry” requests, and materials relating to investigations or complaints. This information comes from a variety of disparate sources in different departments of a typical station business.

Also, these records many times are arranged and maintained differently by each licensee introducing inconsistencies which can make the information more difficult for the public to understand. For a typical researcher or manager, sifting through a large collection of heterogeneous file formats can be exhausting and time-consuming. These inconsistencies can further increase the chances of non-compliance or at least make it more difficult for enterprises handling multiple licensees to stay in compliance. Penalties for failure to properly make the Public File available for inspection can result in significant fines or a loss of the broadcasting license. The foregoing difficulties are compounded by the fact that the FCC can promulgate rules changes, particularly regarding the content required in the Public File, requiring an overhaul of every station's Public File.

With the advent of computer systems there have been only limited improvements in compliance with these FCC rules, relating to document creation. Those systems do not address the deficiencies stated above, but merely add a minimal level of automation. Despite several alterations to the process of compiling and managing the Public File and making it available to the public, the system still suffers from defects, inefficiencies, and inconsistencies which create problems for broadcasting media outlets as well as public media researchers. It would, therefore, be desirable to devise an improved method of creating, maintaining and auditing a media outlet's Public File to better ensure compliance. It would be further advantageous if the method could include more intelligent features to help keep Public Files updated.

### SUMMARY OF THE INVENTION

Features of embodiments described herein provide a workstation kiosk system and method, which satisfies the legal public inspection requirements of FCC-licensed media outlets. The features provide systems and methods of the present invention with the ability to intelligently route Public File documents to the appropriate field entity (local media outlet kiosks) without human intervention, and the ability for local field personnel to electronically input local documents to be verified and audited centrally before posting to the official Public File (kiosk). Once routed these documents are categorized, tagged and made available to the public satisfying the federal requirements. Embodiments of the system allow the workstation kiosks to operate in an offline mode with a synchronization system from the parent server to update the workstation kiosks with documents and system data to operate properly. An alerting system can generate push-email reminders and alerts for key media outlet staff that certain functions must be performed on specific dates including expiration functionality. Additionally, the present invention can provide a virtual workstation kiosk to embed into a media outlet's public-facing websites, providing virtual kiosk access to remote members of the public.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is an embodiment of a configuration editor for email alerting.

FIG. 2 is an embodiment of a graphical user interface (GUI) Service tester for email alerting.

FIG. 3 is an embodiment of a code identifier for high security workstation kiosk installation.

FIG. 4 is an embodiment of a lockdown adjustment for a workstation kiosk.

FIG. 5 is an embodiment of a lockdown confirmation window for a high security kiosk installation.

FIG. 6 is an embodiment of a first tab in the workstation kiosk manager module.

FIG. 7 is an embodiment of a second tab in the workstation kiosk manager module, enabling a user to select media outlets, by market, for kiosk public file display.

FIG. 8 is an embodiment of a third tab in the workstation kiosk manager module for running a kiosk-server synchronization and kiosk update.

FIG. 9 is an embodiment of a GUI for a special key combination password lock feature.

FIG. 10 is an embodiment of a login dialog box to the e-PIF server or workstation kiosk when in administration mode.

FIG. 11 is an embodiment of a change-password dialog box for the administrators.

FIG. 12 is an embodiment of a main server selection screen.

FIG. 13 is an embodiment of a server categories management module screen.

FIG. 14 is an embodiment of a server create/edit category screen.

FIG. 15 is an embodiment of a server market management screen.

FIG. 16 is an embodiment of a server create/edit markets screen.

FIG. 17 is an embodiment of a server edit market screen.

FIG. 18 is an embodiment of a server media property (e.g., station) assignment screen.

FIG. 19 is an embodiment of a server licensee management screen.

FIG. 20 is an embodiment of a server create/edit licensees information screen.

FIG. 21 is an embodiment of a server modify licensees assignment screen.

FIG. 22 is an embodiment of a server manage users screen.

FIG. 23 is an embodiment of a server create/edit users screen.

FIG. 24 is an embodiment of a server manage user to market assignments screen.

FIG. 25 is an embodiment of a server manage stations screen.

FIG. 26 is an embodiment of a server alerting rules engine setup screen.

FIG. 27 is an embodiment of a server content management screen.

FIG. 28 is an embodiment of a server standard categories screen.

FIG. 29 is an embodiment of a server file download dialog box.

FIG. 30 is an embodiment of a server file upload screen.

FIG. 31 is an embodiment of a server political records warning dialog.

FIG. 32 is an embodiment of a workstation kiosk station selection screen.

FIG. 33 is an embodiment of a workstation kiosk main menu screen.

FIG. 34 is an embodiment of an embedded e-PIF link on a media outlet's web site.

FIG. 35 is an embodiment of a server-kiosk system.

FIG. 36 is an embodiment of a computer system programmed to carry out server or kiosk applications.

The use of the same reference symbols in different drawings indicates similar or identical items.

### DESCRIPTION OF THE PREFERRED EMBODIMENT(S)

Described herein are embodiments of a computer-implemented system and method for complying with public inspection requirements. These embodiments may enable broadcasting media outlets to comply with current Federal Communications Commission (FCC), other or future public inspection requirements and enable other media outlets, such as satellite or broadband internet outlets, to comply with current, other or future public inspection requirements. Those skilled in the art will recognize the advantages of a computer-implemented system and method to provide users at broadcasting media outlets the ability to scan, upload, create documents from templates, and modify or automatically populate documents. The present invention thereby allows users to efficiently meet the legal requirements of maintaining a public inspection file. Those skilled in the art will further appreciate the abilities of this system and method to have intelligent features as explained below that reduce user dependence and maintain a higher level of consistency with fewer errors.

Embodiments of the electronic public inspection file system and method described herein are branded as VIERO® e-PIF, and referred to herein as “e-PIF” or the “e-PIF system.” Embodiments provide a multi-tiered computerized platform that can include centralized and decentralized server components, web service layers conforming to service-oriented architecture (SOA), networks and computer kiosks. The e-PIF system provides federally licensed media outlets the ability to manage an electronic public file from one location locally or from a centralized location for enterprise matters and auditing. The e-PIF system is an electronic storage and retrieval system that can give the local FCC licensee total control of their public files for all stations in their respective market as well as enterprise control for high level corporate roles. With e-PIF, management of the system is set up during installation to reflect the business operations. The e-PIF system makes it easy for a central auditor to oversee all stations or markets and to help each one stay compliant. Without the e-PIF system, when someone wants to view a station's public files, they typically would be directed to a file cabinet where the documents are stored as physical papers, and be allowed to sift through them. Those skilled in the art will appreciate how, in contrast, the ePIF system turns file retrieval into a quick, self-service operation. When visitors use an e-PIF workstation in the lobby of a local licensee, they can quickly view and print the station's files. A media outlet user can also post public files to a media outlet website so that interested parties can review those public files.

One embodiment of the e-PIF system is segmented into two functional subsystems. The server layers manage the authoritative process such as master document management, workflow and security. The kiosks workstations located for public access can provide posting, viewing and printing for members of the public that visit the media outlet.

The server layers perform the master tasks of the e-PIF system and method. Embodiments of the database servers employ, but are not limited to, Microsoft SQL and MySQL servers, and do the heavy lifting of managing the documents and images. The e-PIF system provides default categories that carry expiration dates for the documents and images contained in the system. Default categories might include: TV children's programming reports, TV-must carry/retransmission consent, citizens' agreements, political records, public comments, and quarterly issues reports which require a selection of a quarter and a year. An e-PIF administrator can create additional categories if required. Web technologies provide communications such as web services to other servers and the workstation kiosks (for administrators, not public kiosk users).

A novel aspect of embodiments described herein is the workstation KIOSK_ID structure and system. Each workstation kiosk is segmented and structured to match the legal entity schema as defined by corporate law and the FCC. Because of various mergers and acquisitions, the legal entities holding the FCC licenses can be varied and complex within a large corporation. For example, one company may be a licensee in name only, with another company effectively owning the station and doing all the work of programming and operating the local office. These complications and other legal relationships can cause workflow for Public File reporting and access to become varied and complex. The embodiments described herein solve this challenge by creating a unique KIOSK_ID and providing a system with a structure to map to the legal entity hierarchy. Metadata and tags such as corporation names and FCC call letters can be used to index and search the workflow. In preferred implementations this system allows for complete hands-free management of the top-down transmittal and filing of enterprise-level FCC documents at the main studio of the station.

Workflow engines within the server(s) can provide business rules execution, based on user configurations as well as predefined system rules. An example of a workflow process is the ability to have a single document, which was sent to the corporate headquarters and that impacts each of or subsets of the local federally-licensed media outlets, automatically transmitted to and available on the kiosk workstations of the media outlets without manual intervention. Another example of workflow functionality is when documents are created, scanned or altered, various user roles can be notified to approve them prior to activation at the workstation kiosks, for example based on the document category. Alert engines can provide time-sensitive alert messages to be managed through workflow. An example of this functionality is a quarterly issues email alert. FCC rules require that a set of documents be created each quarter identifying issues affecting the public. The alerting engine can send first reminders through email on the first day of every month after the quarter ends. The reminders are sent to one or more designated recipients within the media outlet. A second email alert may be sent on the fifth day of the month, possibly to different designated recipients (generally a higher-level role within the media outlet if the quarterly issues file has not been completed and uploaded). A third email alert may be sent to again a different set of recipients on the tenth day of the month if the status has not been brought current.

As mentioned above, these documents can be manually constructed from templates but usually will benefit from the intelligent auto-creation feature in e-P1F. This feature allows the automatic generation of documents using the templates populated by information associated with different workstation kiosks. Another of e-P1F′s unique features is to automatically remove expired documents from visibility to the public and archive them. The server can send an expiration reminder a few days before a document is set to expire. These reminders allow administrators to extend the expiration date if necessary, or to re-evaluate whether the document in question should really be allowed to expire. If no action is taken by the administrator, the system will remove the document from view once the expiration date comes.

Security engines within the server layers can provide translation between organizational roles and functional duties. The e-P1F system preferably utilizes integrated directory services such as Microsoft's active directory for organizations that need user authentication to bypass login procedures. Table 1 shows an example of security levels with associated users and documents.

TABLE 1

| Security | |
|---|---|
| Level | Description |
| Safe Mode | This level only allows users to view documents (e.g., the |
| (restricted | public). |
| access) | |
| * | Most e-PIF system users (station employees or agents) will |
| | have level 1 access, which allows them to upload most files |
| | and edit any level 1 documents. |
| | Level 1 users cannot delete documents, assign documents to |
| | licensees, or mark documents as global (viewable in all |
| | stations). |
| ** | Level 2 users may include Public Affairs Directors and other |
| | high-level management. Level 2 users can upload most files |
| | and edit any documents with level 1 or level 2 access, and |
| | can delete and edit any documents with level 1 or level 2 |
| | access |
| *** | Level 3 users may include corporate auditors or legal staff |
| | responsible for station compliance. Level 3 users can upload |
| | and edit any documents, delete any documents, assign docu- |
| | ments to licensees, and mark documents as global (viewable |
| | in all stations) |

In some embodiments Level 1 documents include files such as quarterly reports, issues/answers, and complaints. Level 2 documents include files such as political broadcasts and donor lists. Level 3 documents include files such as ownership reports. The e-PIF system advantageously supports a variety of file types using appropriate vendor-supplied applications, including bitmaps (.bmp), Microsoft Word (.doc), graphic interchange format (.gif), hypertext markup language (.html or .htm), Joint Photographic Experts Group (.jpeg or .jpg), mime html (.mht), portable document file (.pdf), portable network graphics (.png), rich text (.rtf), and ASCII text (.txt).

The workstation kiosks are the public-facing components of the e-PIF system. Embodiments of the workstation kiosks provide a set of features and functionality to minimize user errors and provide advanced information retrieval. In one embodiment, each workstation kiosk contains some components of the server layers. The workstation kiosks can be managed through master KIOSK_ID's that are tokened through the install process to create the tree of nodes needed to operate the system. The KIOSK_ID process in essence defines the legal entities to enable the automated workflow and security. Workstation kiosks can operate in a standalone mode without networking by storing Public File information locally, as required by the FCC for acceptance of electronic rather than paper storage of public file information. Those skilled in the art will acknowledge the unique ability to provide for offline operations of the kiosks. This feature allows for the kiosk workstations to synchronize with the parent servers at selected times when networking is available but still fully function when networking is no longer present. The workstation kiosks can have their keyboards mapped with shortcuts to provide users quick and easy access to predefined functions specific to the tasks of public file inspection. Kiosks can further have an associated printer to enable printing of accessed Public File documents. Moreover, as described herein, embodiments enable kiosk functionality to be accessed via the Internet, providing virtual kiosks at nearly any location.

Kiosks may be marked to indicate how up-to-date they are, i.e., when the last update was. The markings may be visible at the server management level in association with the different kiosks being managed, and can also be displayed locally as part of the kiosk interface. Workstation kiosk updating icons can for example include a green check mark indicating that the last sync occurred within 24 hours or less, a yellow exclamation mark indicating that the last sync occurred more than 24 hours ago but less than or equal to 96 hours, and a red X mark indicating that the last sync occurred more than 96 hours ago.

The kiosk workstation is preferably installed with a High Security level allowing many keyboard features to be disabled. However, in this mode users still have access to alphanumeric keys for interacting with the kiosk. Enabled keys of a 101-type keyboard can include:
letter keys (A-Z);
number keys (0-9);
symbol ˜eys, TAB, SPACE, and ENTER;
Home, End, Page Up, and Page Down;
Shift (left); and
Ctrl (right).
   Keys and functions that are preferably disabled include:
Escape;
Programmable Function keys (F or PF keys);
Print Screen;
Scroll Lock;
Pause/Break;
Backspace;
Insert;
Delete;
Num Lock;
Number Pad (all numbers, operators, Delete, Insert, Enter);
Caps Lock;
Alt (left & right);
Ctrl (left);
Shift (right);
Windows key (left &right);
Context Menu/Application; and
specialty keys such as power management keys, application launch keys, media keys, or other keys on specialized keyboards.
   Right-clicking with the graphical pointing device (mouse) of the kiosk is also disabled system-wide.

Below are various illustrative figures depicting embodiments of various aspects of an embodiment of the system and method described herein. Most of the figures illustrate screens and/or graphical user interfaces (GUIs) that are displayed by system servers described herein on a server display or on a workstation in communication with a server. These screens enable users, particularly system administrators, to set up various aspects of the system, configure kiosks, perform various system processes including kiosks synchronization and updates, and otherwise interact with the system. In an embodiment, these same screens and functionality may be accessed by an administrative user on a kiosk, using secure (e.g., password) access.

Also shown are kiosk screens as indicated. These screens are presented to a user accessing the kiosks on a display device at a local media outlet or other authorized location (e.g., public library, attorney's office, etc.) to view and access Public File documents in response to user control and selection using the keyboard and mouse. As described herein, these screens and similar interfaces may be accessed through the Internet, providing virtual kiosk access.

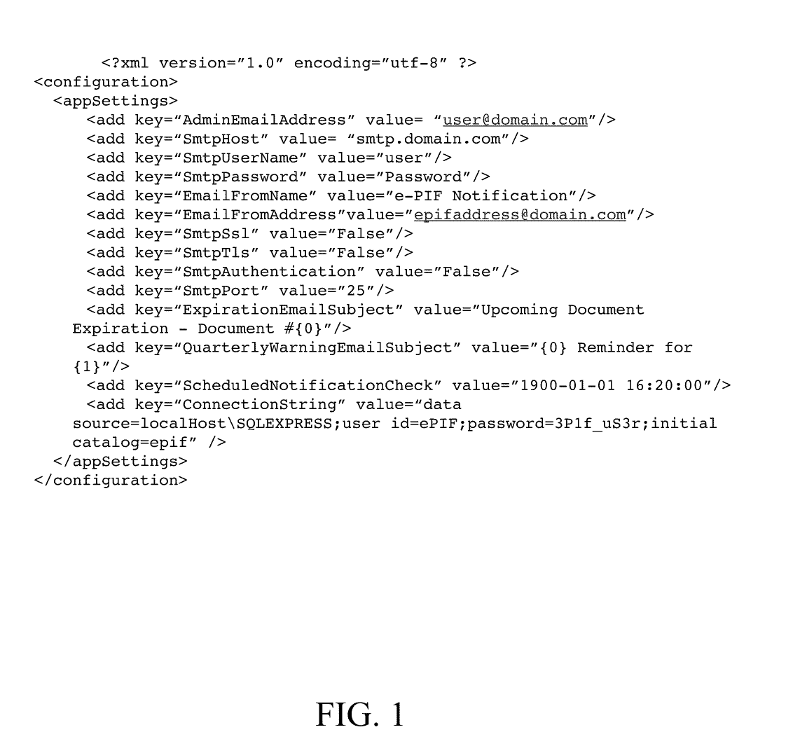

FIG. 1 depicts one embodiment of a configuration editor constructed in accordance with the present invention. The configuration editor is designed for the purpose of altering certain application settings, i.e. setting key values such as user names, passwords, and email addresses. The configuration editor may be written in extensible markup language (xml).

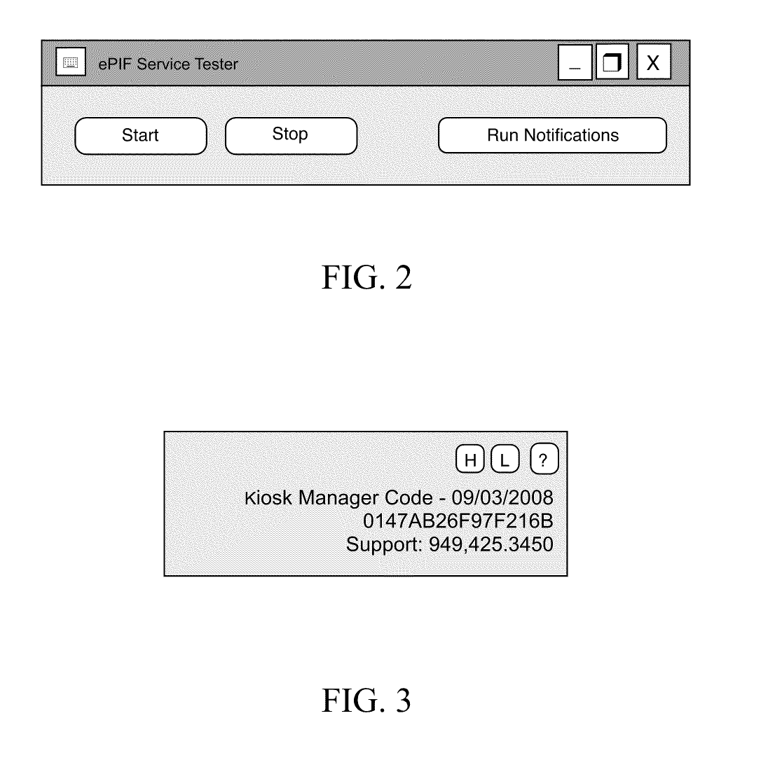

FIG. 2 is a representation of an e-PIF service tester rendered in a graphical user interface (GUI). The service tester executes when the start button is selected, and the process can be halted by selecting the stop button.

High security workstations can have an associated code identifier for installation, one of which is depicted in FIG. 3. The code identifier includes information such as the kiosk manager code and a support number.

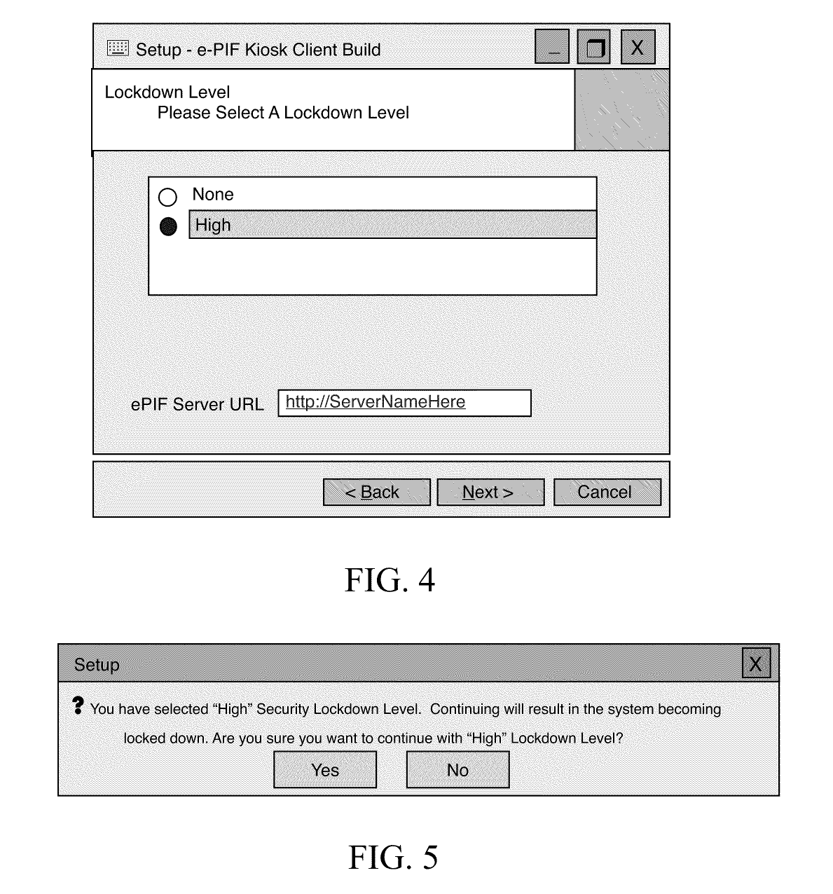

The lockdown level for a given kiosk can be specified using the lockdown adjustment window shown in FIG. 4. The lockdown levels available for selection here are “None” and “High.” The e-PIF server address for the server being utilized is specified in e-PIF Server URL field. An example of a lockdown confirmation window is shown in FIG. 5. This window is displayed when an administrator selects the “High” lockdown level in lockdown adjustment window of FIG. 4.

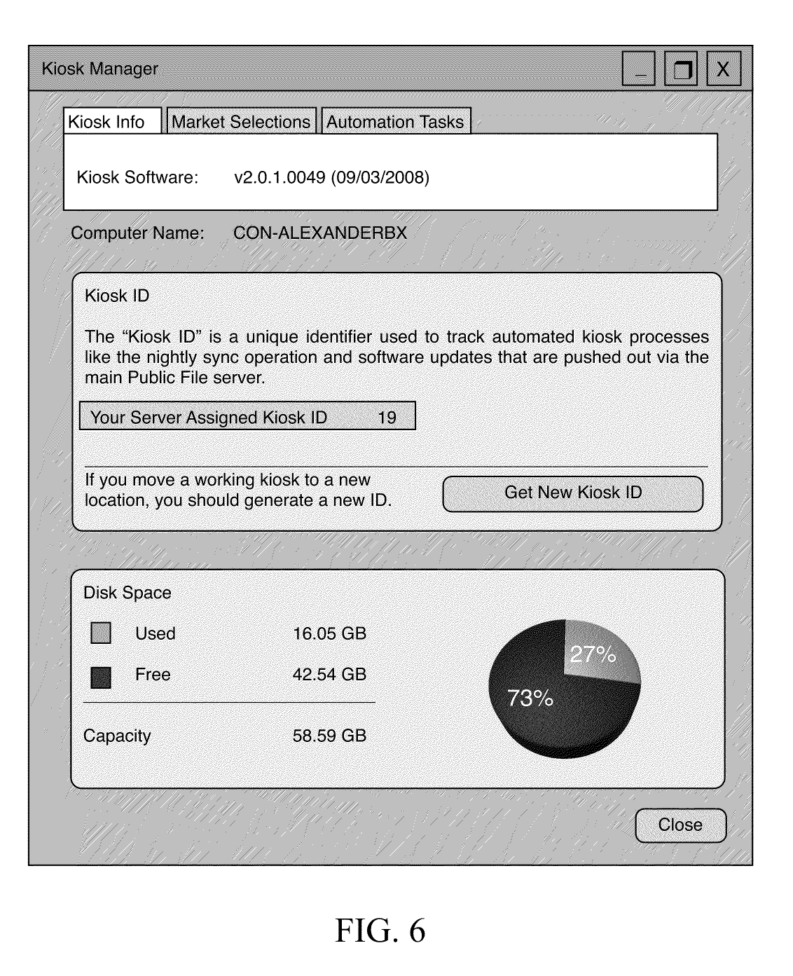

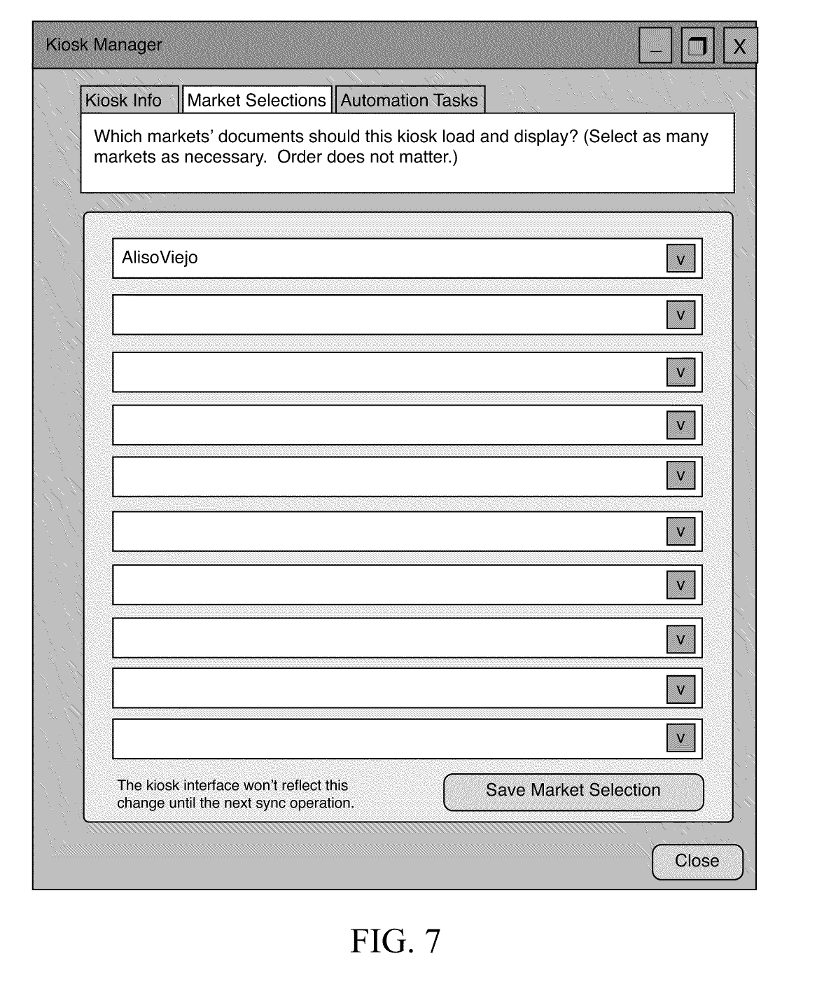

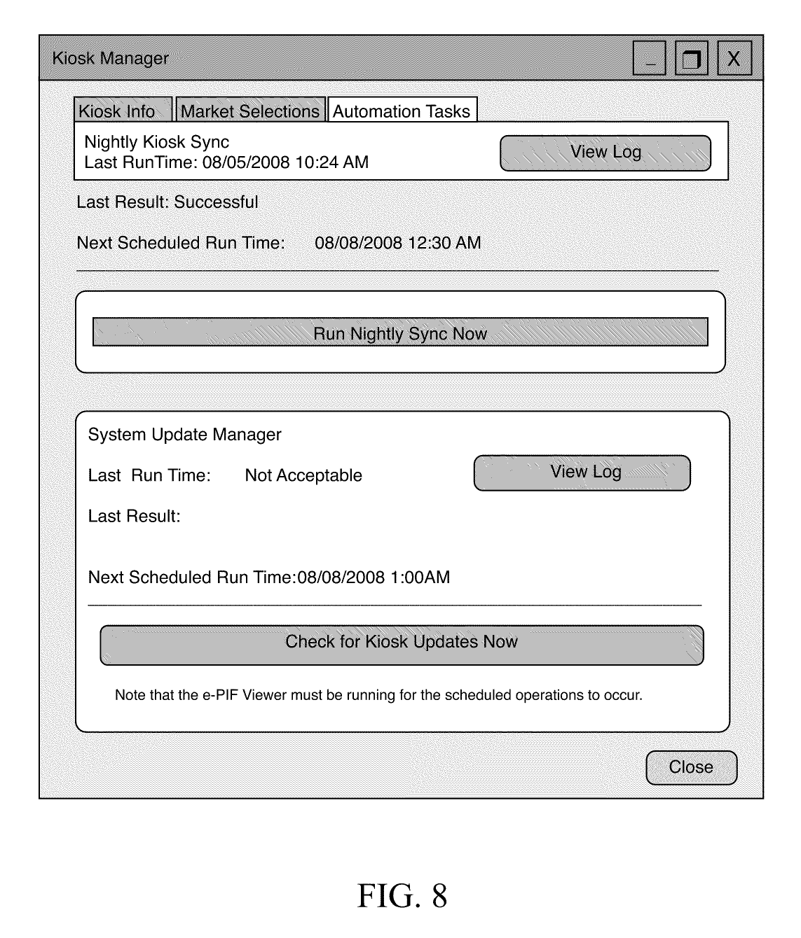

FIG. 6 is one illustration of the primary interface used by an administrator to manage remote kiosks, i.e., a workstation kiosk manager module. In the particular illustration, the Kiosk Info tab has been selected in the workstation kiosk manager module. Other tabs which can be selected are a Market Selections tab and an Automation Tasks tab. The Kiosk Info tab presents information pertaining to a specific kiosk, including kiosk software, a computer name, a kiosk identifier (ID), and disk space. A new kiosk ID can be generated by selecting the Get New Kiosk ID button (usually done immediately after a kiosk has been relocated). The kiosk transmits its ID to the server during synchronization. Workstation kiosk manager module is also displayed in FIG. 7, but with the Market Selections tab selected. In this configuration, an administrator can determine which markets' documents are loaded and displayed on the given kiosk by selecting the desired market from a pull-down list for a given market selection field. The workstation kiosk manager module is also displayed in FIG. 8, but with the Automation Tasks tab selected. The two main automation tasks for a given kiosk are a nightly sync and a system update. A log containing sync/update times can be displayed by selecting the View Log button for the corresponding automation task. If an administrator desires to sync the kiosk with its server (to get the most current Public File information), the administrator can simply select the Run Nightly Sync Now button. If an administrator desires to check for kiosk system updates (relating to the programming of the kiosk), the administrator can activate the Check For Kiosk Updates Now button. System updates can change features of the kiosk such as keyboard or mouse functionality, the graphical interface for the public, vendor applications that are launched to display or print the documents, etc.

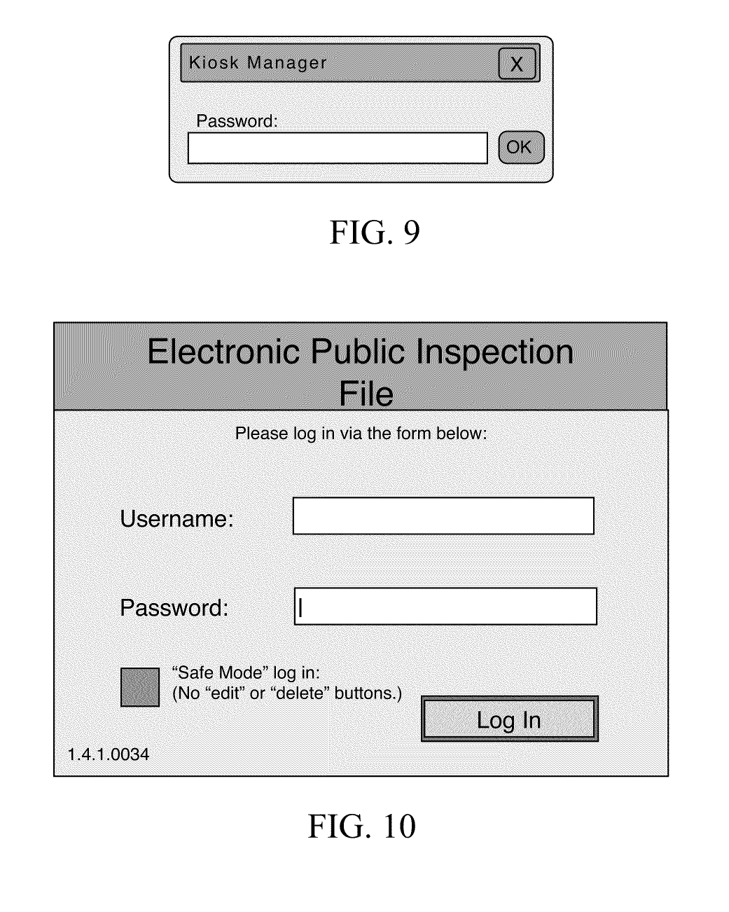

A given kiosk can be configured such that a key combination password is required to unlock the kiosk for any use. The kiosk can be unlocked by a user entering in the correct key combination password in the password field of a keyboard lock window as seen in FIG. 9.

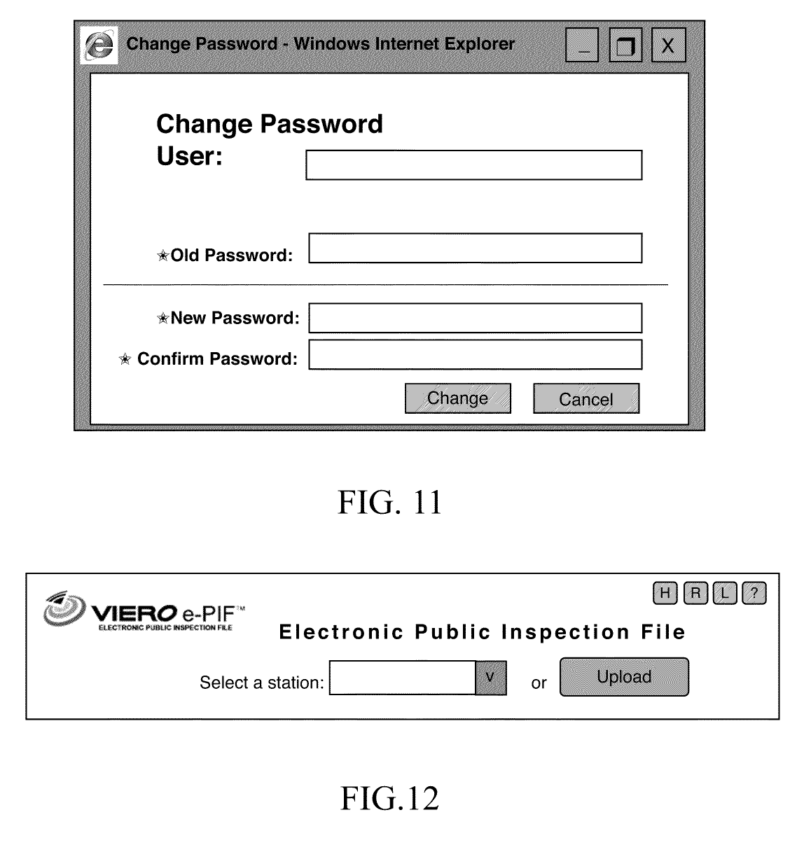

One mode in which an e-PIF server or workstation kiosk can be operated in is an administration mode. A unique feature of this mode is the electronic public inspection file login screen shown in FIG. 10. An administrator can sign into this system by entering a valid username and password in the username and password fields respectively, and then selecting the Log In button. An administrator also has the ability to change the password used for a given username. This is accomplished by using the password dialog box illustrated in FIG. 11. The original password is entered into the old password field, and the new password is entered in both the new password field and the confirm password field, and then the Change button is selected.

A typical main server selection screen is shown in FIG. 12. This screen enables a user to select a kiosk station from a station pull-down list, or upload information for a new kiosk station.

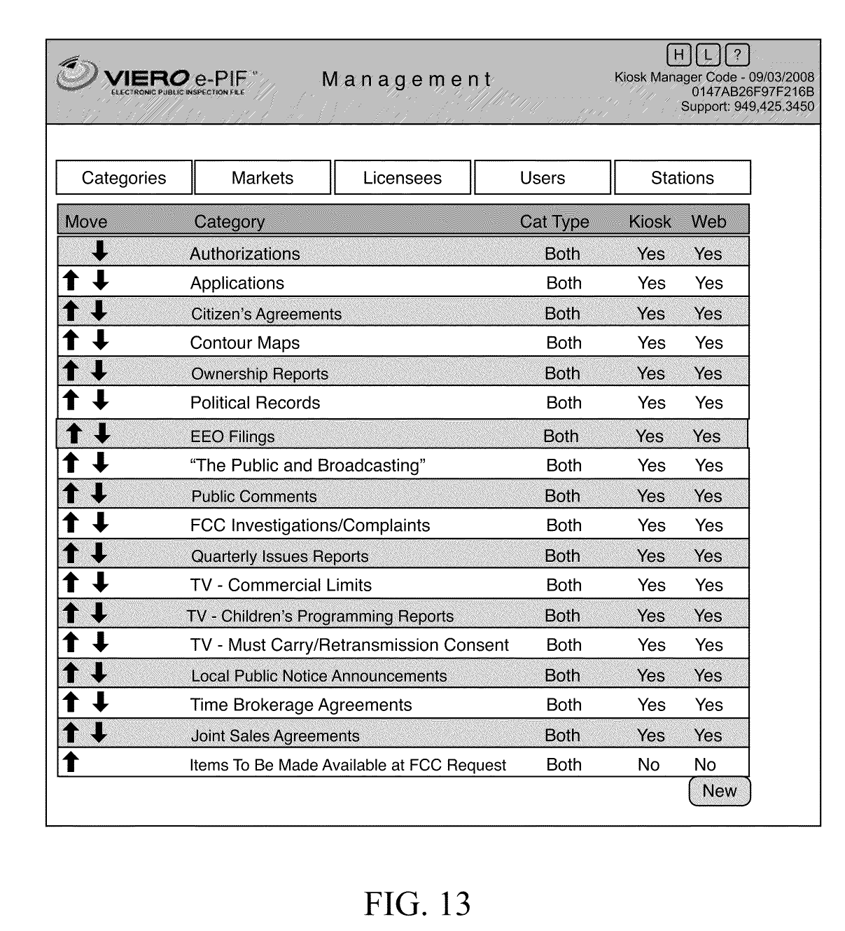

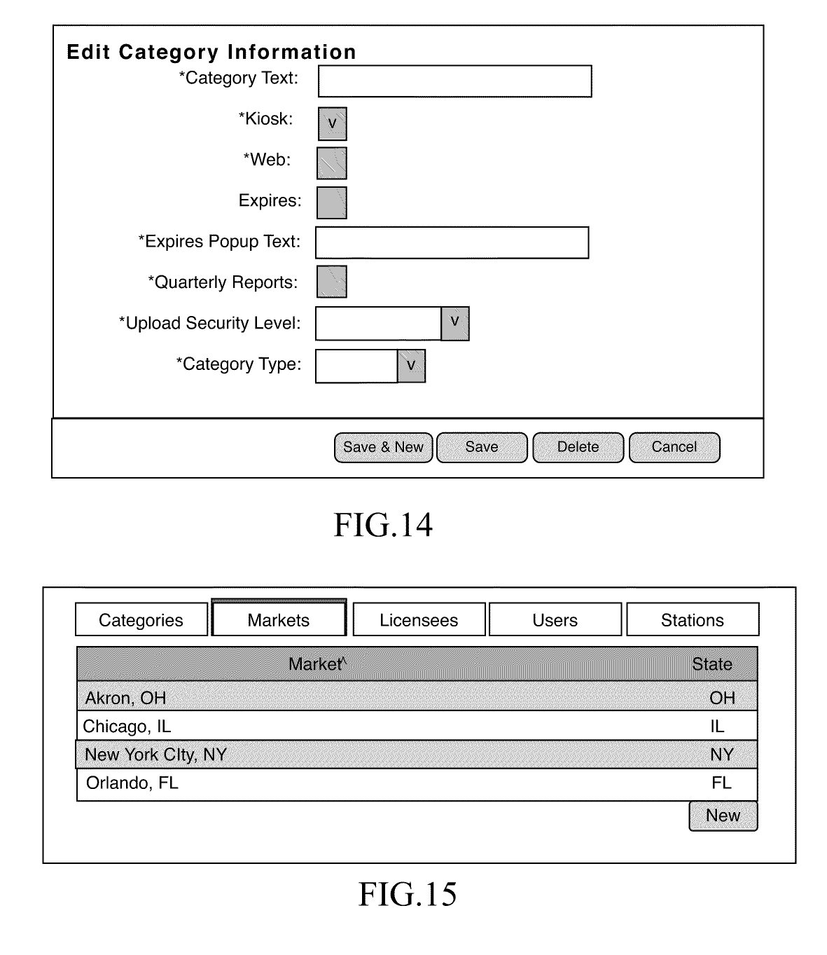

FIG. 13 shows a server categories management screen with a Categories tab selected. The Categories tab shows a list of documents categories, i.e., the various types of documents that may be currently required by applicable laws or guidelines. A new category can be added by using the New button. Each category in the Categories tab can be edited using the create/edit category screen illustrated in FIG. 14. A given category is specified using the category text field. The new category can be marked for inclusion in kiosks, the Web, and/or quarterly reports, and may have an expiration date, a security level, and a category type. If the document is one that expires, a text for a popup message can be entered in the popup text field. Kiosks will compare documents that might expire to the current date, and will not display expired documents to the public.

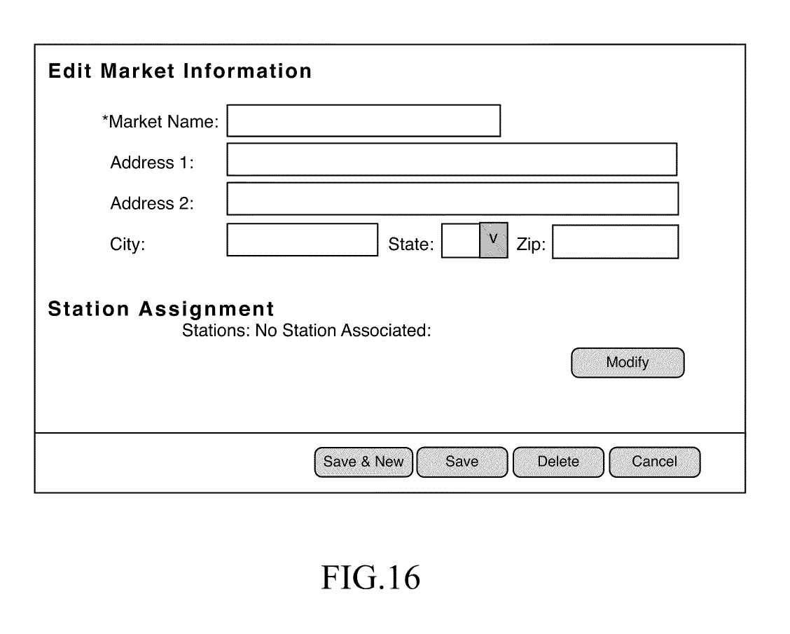

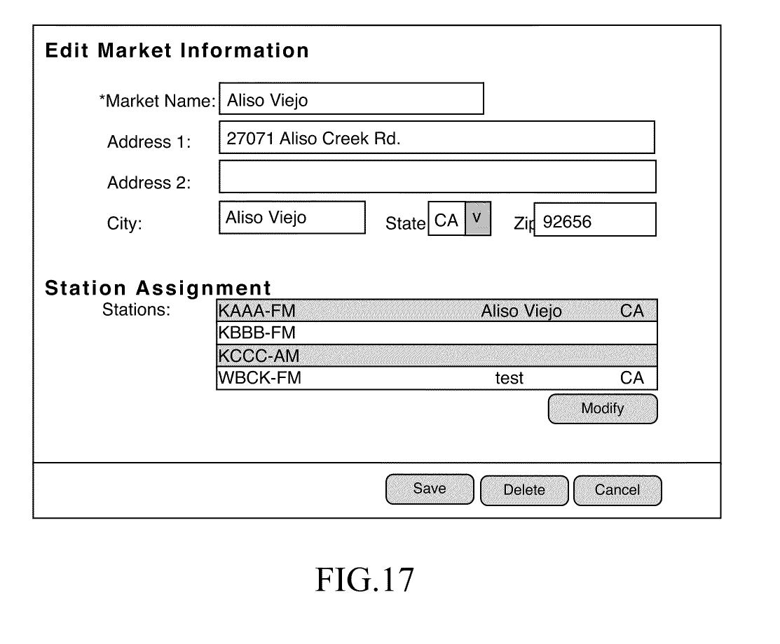

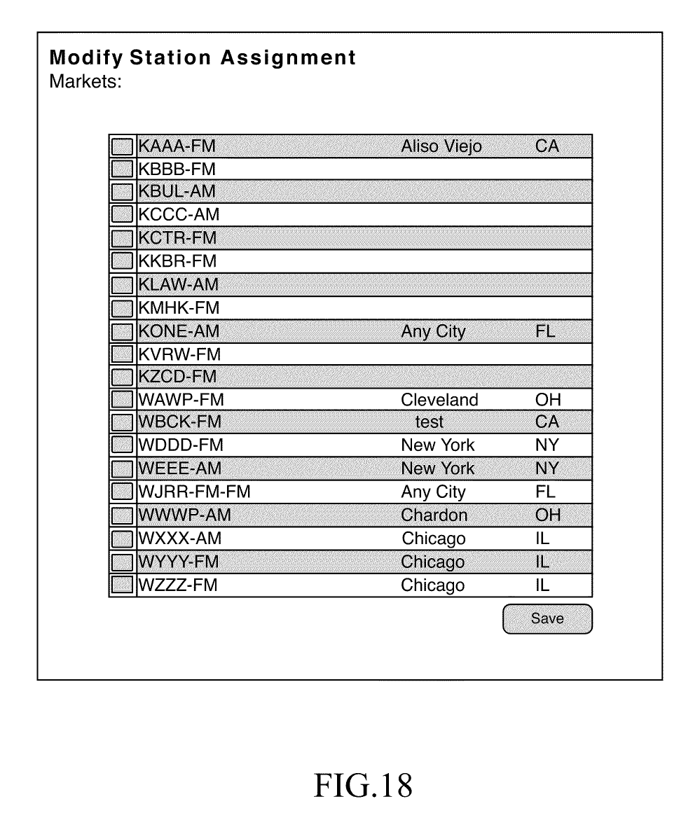

FIG. 15 illustrates the server management screen with the Markets tab selected. In this particular illustration, the markets listed on the screen happen to be metropolitan areas. A new market can be added to the market list by using the New button. Markets can be edited/created using the create/edit markets screen illustrated in FIG. 16. The name of a market is specified in the market name field, and stations can be assigned to (associated with) the market by using the modify button. FIG. 17 is another representation of the create/edit markets screen with a list of assigned stations added for the Aliso Viejo market. Selecting the modify station market assignment button will cause the modify station market assignment screen to be shown as seen in FIG. 18. To assign a station (media property) to a market, the station is selected from a list of available stations by checking the corresponding station check box.

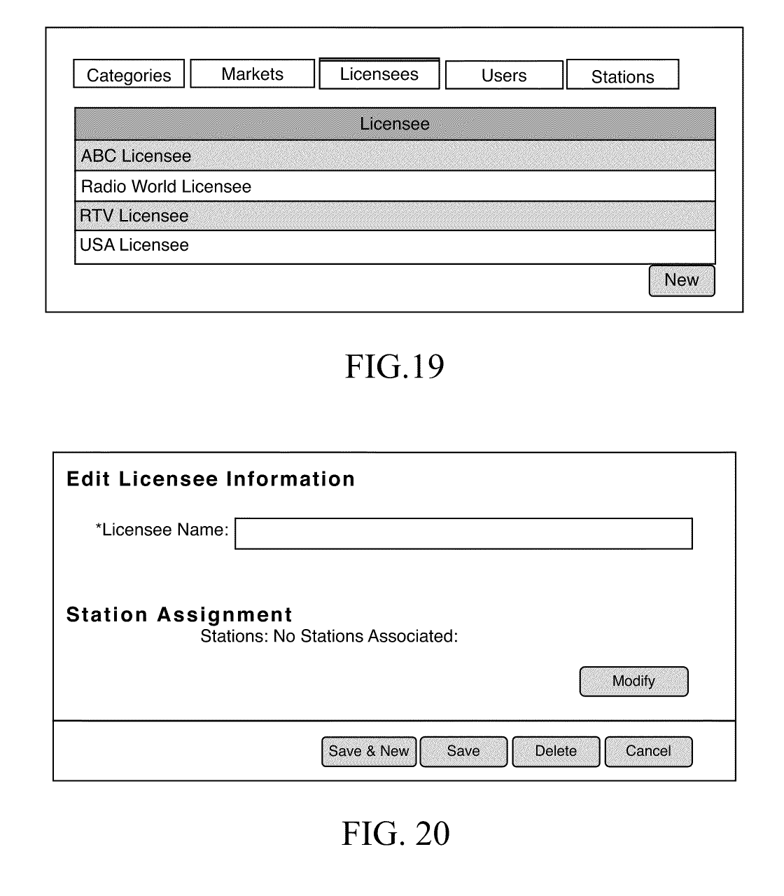

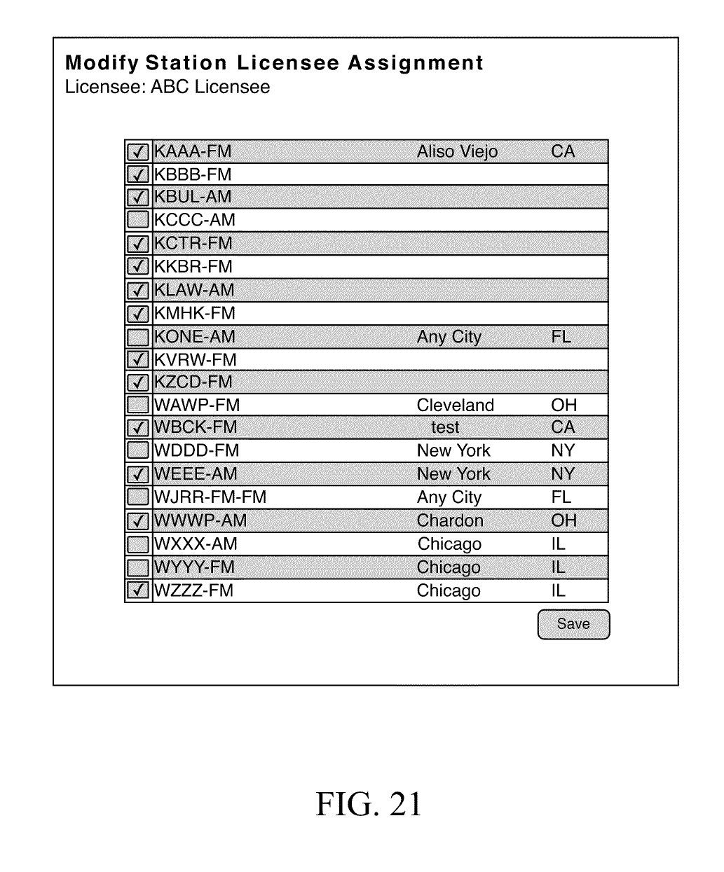

FIG. 19 illustrates the server management screen with the Licensee tab selected. A list of licensees is shown for this tab, and a new licensee can be added using the New button. Licensees can be edited/created using the create/edit licensee screen shown in FIG. 20. The name for a given licensee is specified in the licensee name field, and stations can be assigned to the licensee by using the Modify button. Selecting the modify station licensee assignment button causes the modify station licensee assignment screen to be shown as seen in FIG. 21. To assign a station to a licensee, the station is selected from the list of available stations by checking the corresponding station check box.

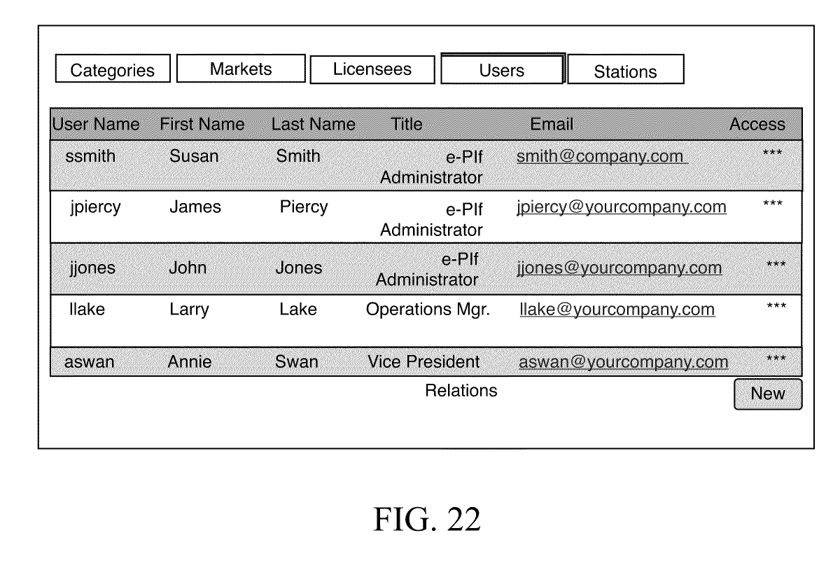

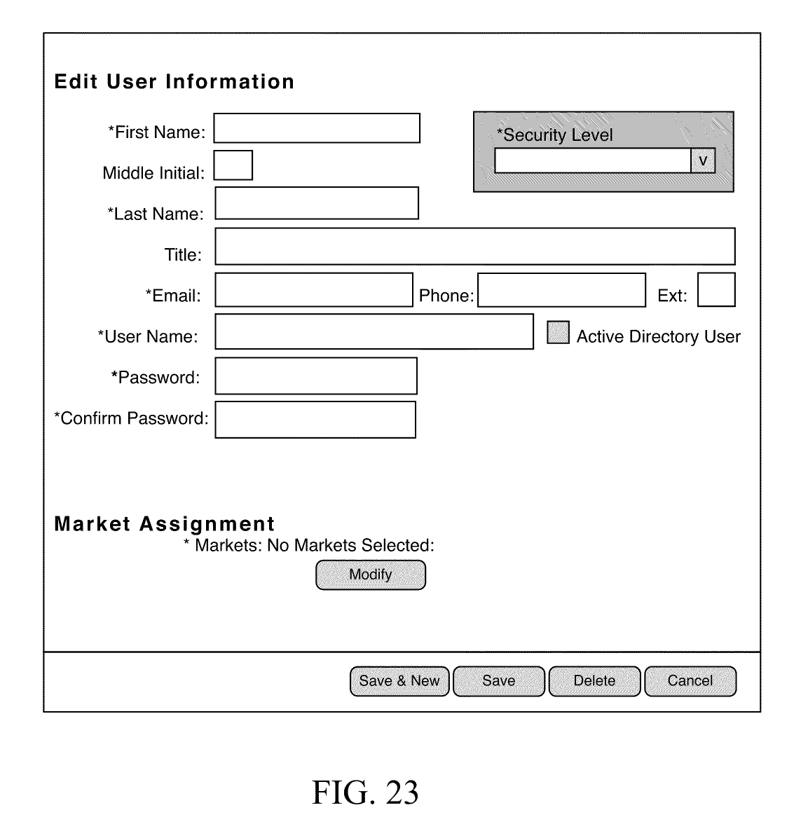

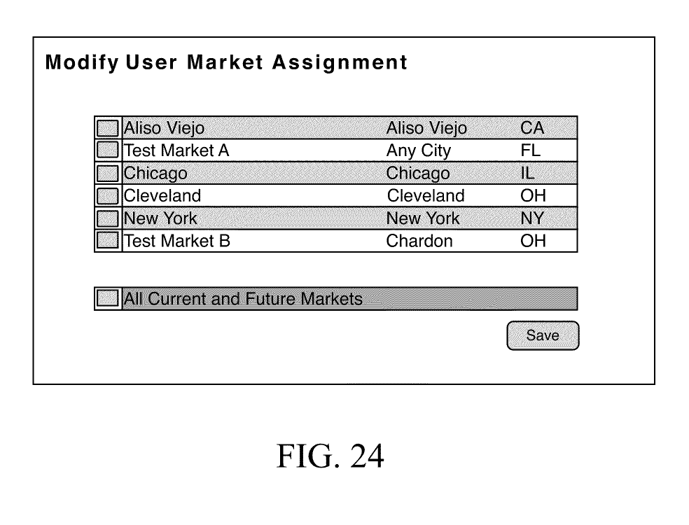

FIG. 22 illustrates the server management screen with the Users tab selected. A list of users is shown for this tab, and a new user can be added using the New button. Users can be edited/created using the create/edit user screen shown in FIG. 23. The first name for a given user is specified in the user first name field, and the last name for a given user is specified in the user last name field. The password which that user must enter in order to sign into their account is specified in the user password field. A user's security level can be selected from the security pull-down list. Markets can be assigned to the user by using the modify market user assignment button. Selecting the modify user market assignment button causes the modify user market assignment screen to be shown as seen in FIG. 24. To allow a user to administer a particular market, the market is selected from a list by checking the corresponding market check box.

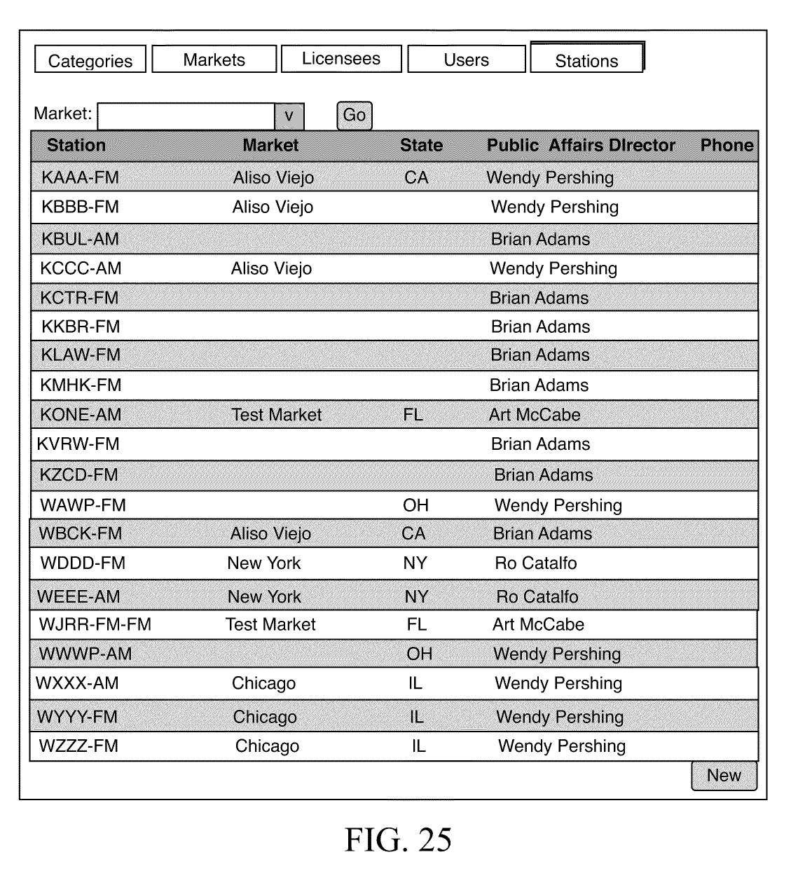

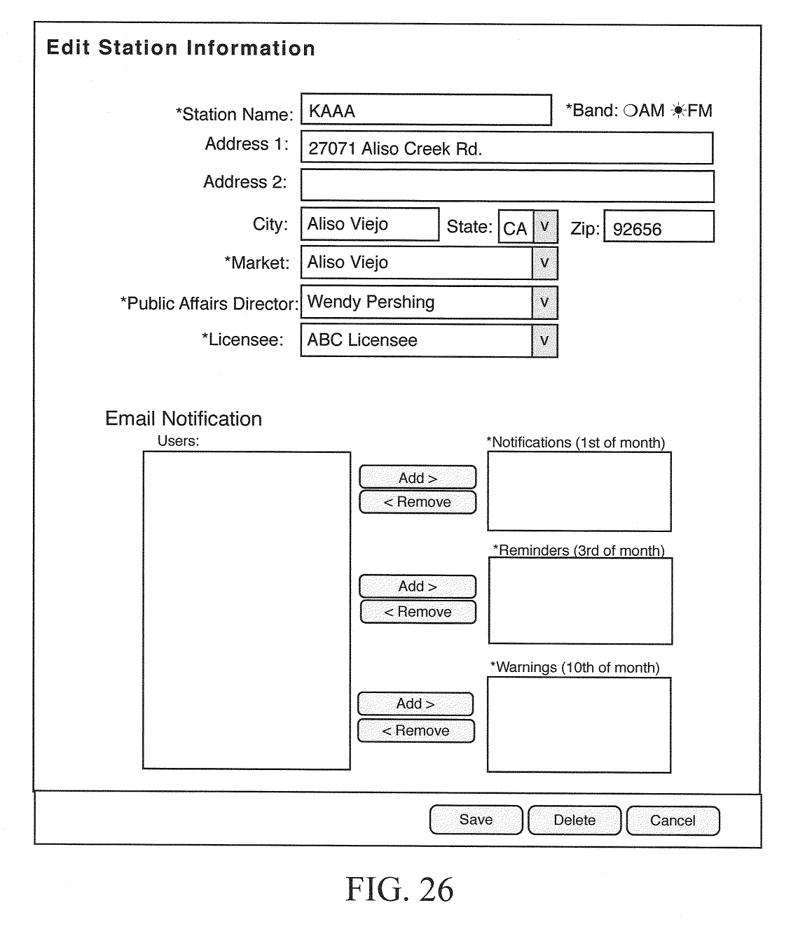

FIG. 25 illustrates the server management screen with the Stations tab selected. A list of stations is shown for this tab, and a new station can be added using the New button. Stations can be edited/created using the create/edit station screen shown in FIG. 26. The name of the station is specified in the station name field, and the address for a given station is specified in the address fields. Additional information such as markets, public affairs director, and licensee can be selected from pull-down menus. The create/edit station screen also has an email notification section showing all available users and sets of Add/Remove buttons to compile lists for receiving different reminders regarding this station.

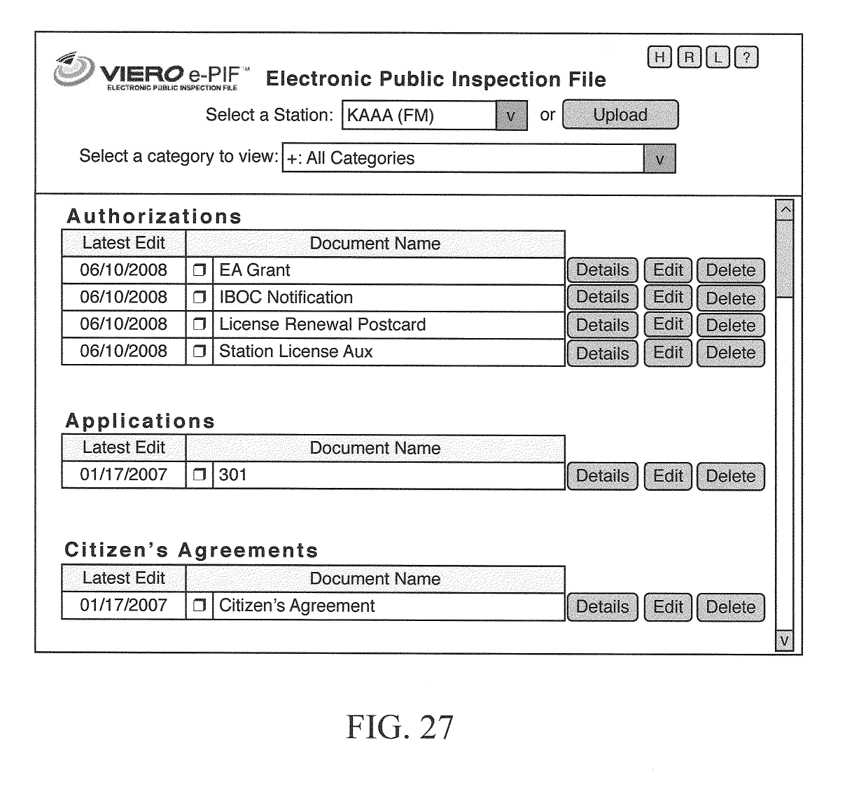

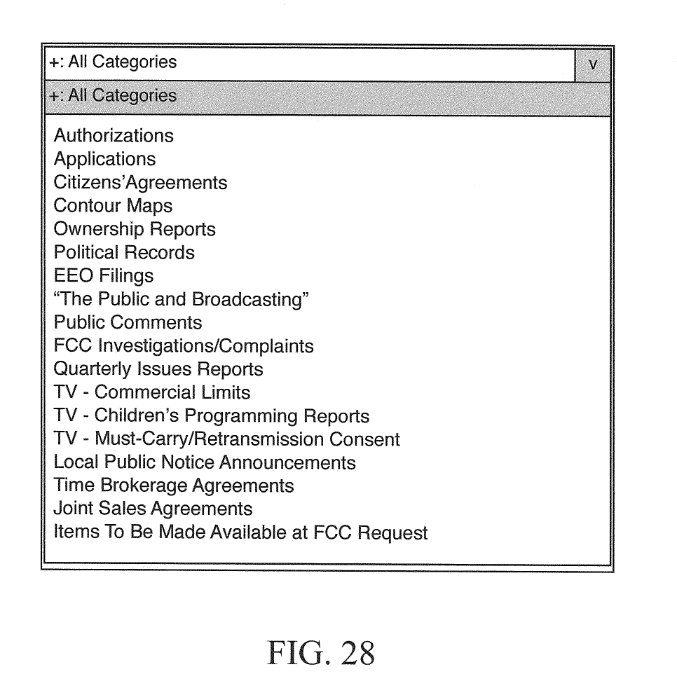

Server content can be managed using the server content management screen illustrated in FIG. 27. A given station is selected from the station pull-down menu, and the category of documents to view for this station is selected from the categories pull-down menu. In this example all categories have been selected but only the Authorizations, Applications and Citizens' Agreements are available in the viewable area. Documents in other categories can be seen by scrolling down this screen. Clicking on any of the document names causes the appropriate vendor application to launch and open the selected file. A list of exemplary categories is shown in the pull-down menu of FIG. 28.

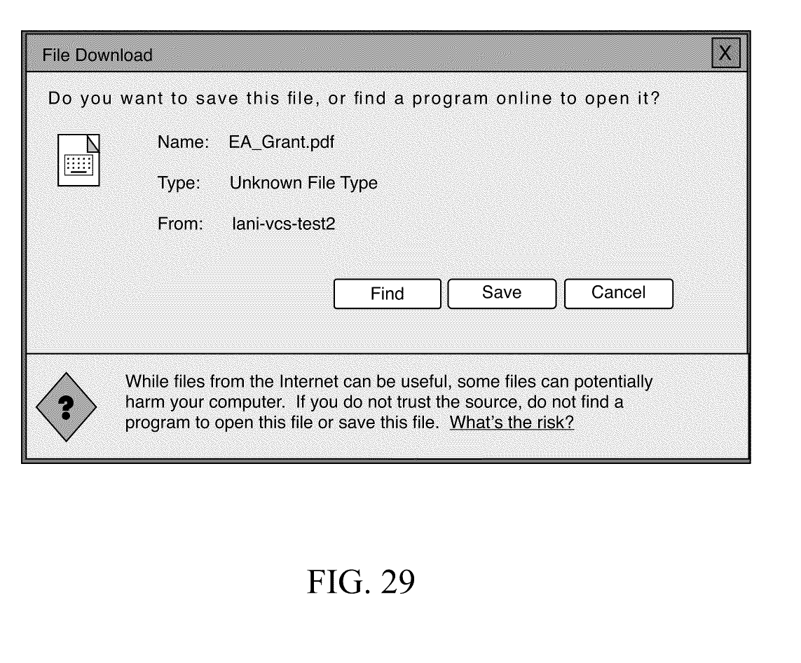

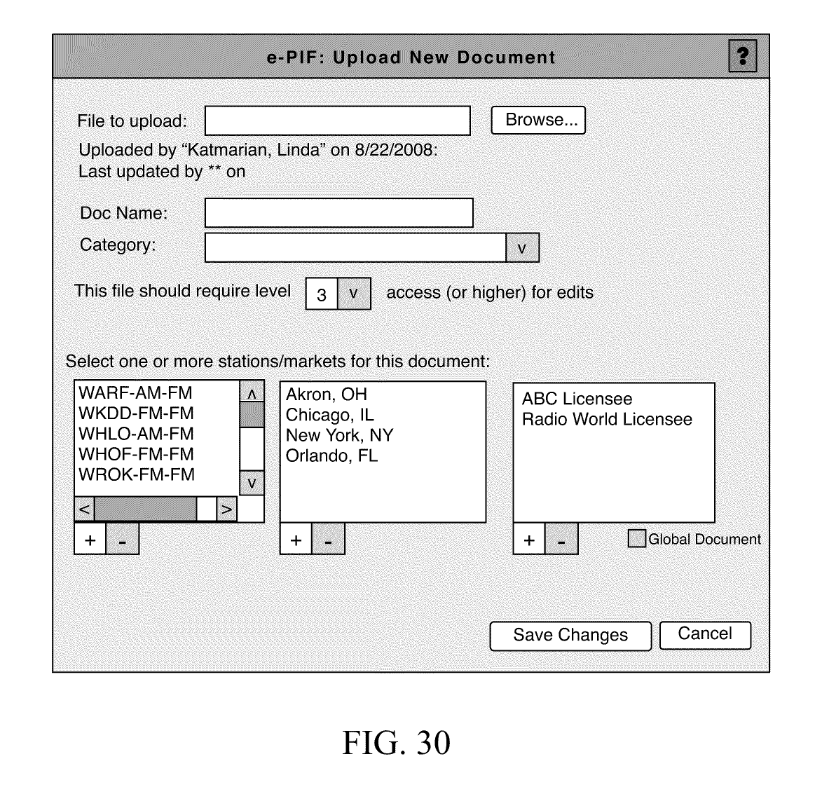

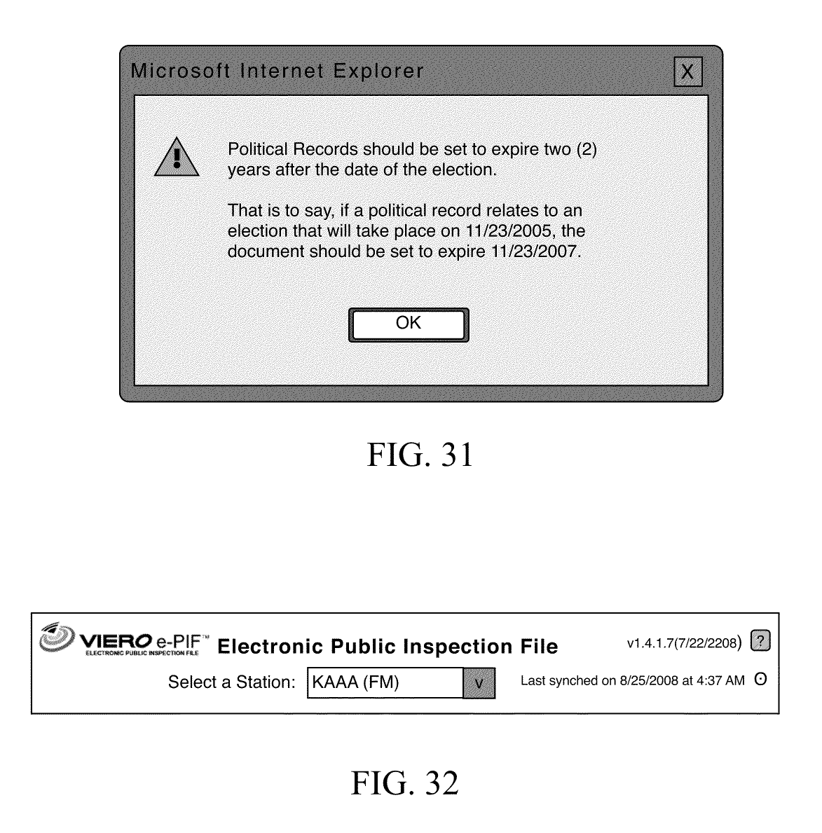

The server administrator can download files from remote sites via the Internet or other network as illustrated by the server file download dialog box of FIG. 29. Once the files have been downloaded to the server storage device they can be uploaded to appropriate kiosk files using the server file upload screen illustrated in FIG. 30. The server file upload screen includes a field for entering the file name/path on the server storage device and a Browse button which can be used to open a directory search window. A document name is given to the file by entering it in a document name field. The document name will be used by the public interface of the workstation kiosk. The server administrator can also assign a category to the document using the category pull-down menu. The file will be uploaded with these attributes to each kiosk corresponding to any combination of stations, markets or licensees selected from those listed in the station pane, the markets pane, or the licensees pane. For example, selecting only the Akron, Ohio market will result in the document being uploaded into the kiosk Public Files (stored at the server) for every radio station in the Akron geographic area that has been entered into the e-PIF system, i.e., every “main studio” managed by the company in this area. The e-PIF system can include warnings as desired for particular types of documents as they are uploaded. FIG. 31 illustrates a warning dialog box to remind the administrator that political records should be set to expire two years after the date of an election. The modified Public Files which include any uploaded files will be transmitted to the kiosks and/or web during the next scheduled sync.

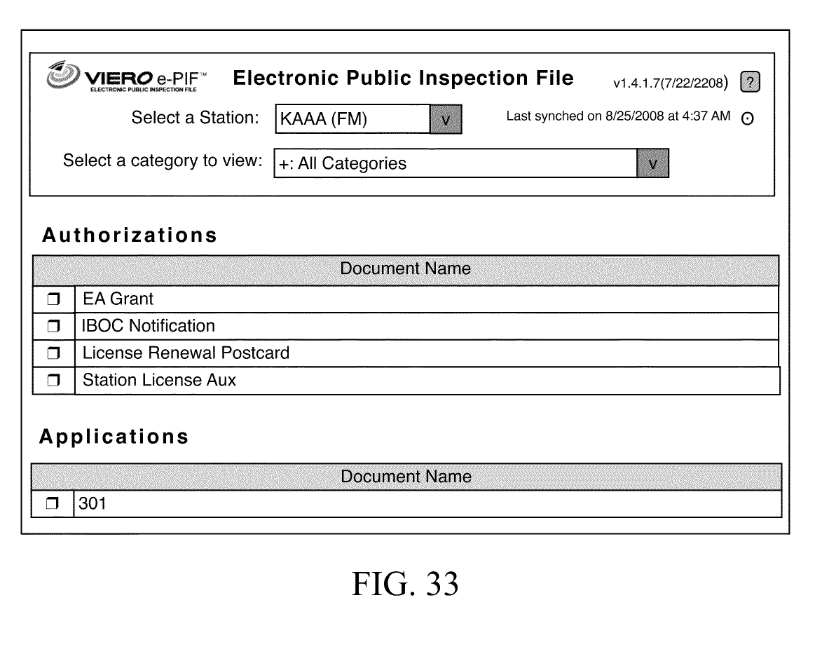

A public user can be presented with the station selection screen shown in FIG. 32 to enter a desired station from a pull-down menu, so a single kiosk can provide Public Files for more than one station in case several stations are co-located. Once a station is selected the main menu screen can be displayed as shown in FIG. 33. The kiosk main menu screen is similar to the server context management screen of FIG. 27 in that they both allow viewing of station Public File documents, sorted by category according to the category pull-down menu. The main menu screen retains the station pull-down menu so the user can quickly switch to another station Public File. An entire document can again be viewed by clicking on the document name to launch the appropriate vendor application and open the selected file. The applications can include print functions to allow any file to be printed on a printer proximate the kiosk. In this manner, the only maintenance required at the kiosk is the refilling of paper and ink/toner.

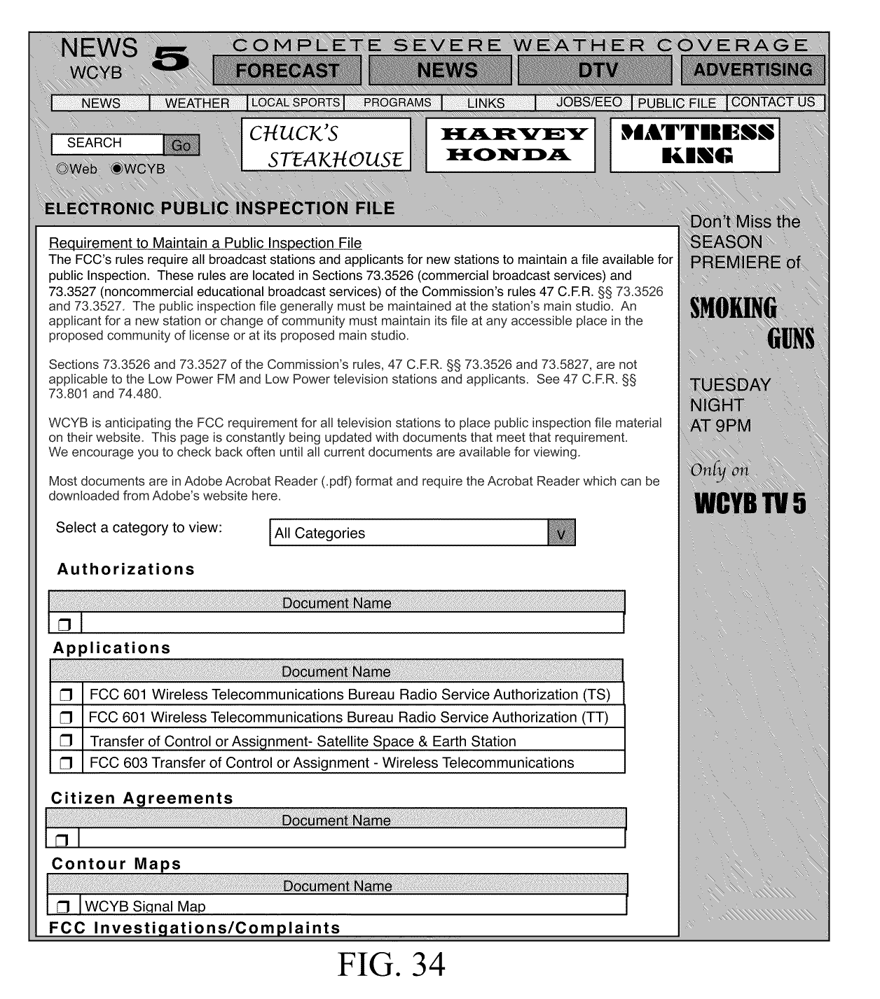

The kiosk can also be virtualized by providing an internet-accessible link. FIG. 34 shows an example of an embedded e-PIF link in a web page for a media outlet (WCYB television). The link displays a frame within the web page that allows the user to select a category for the Public File documents with a category pull-down menu, and below this menu shows the various Public File documents which again can be accessed by clicking with the graphical pointing device of the kiosk.

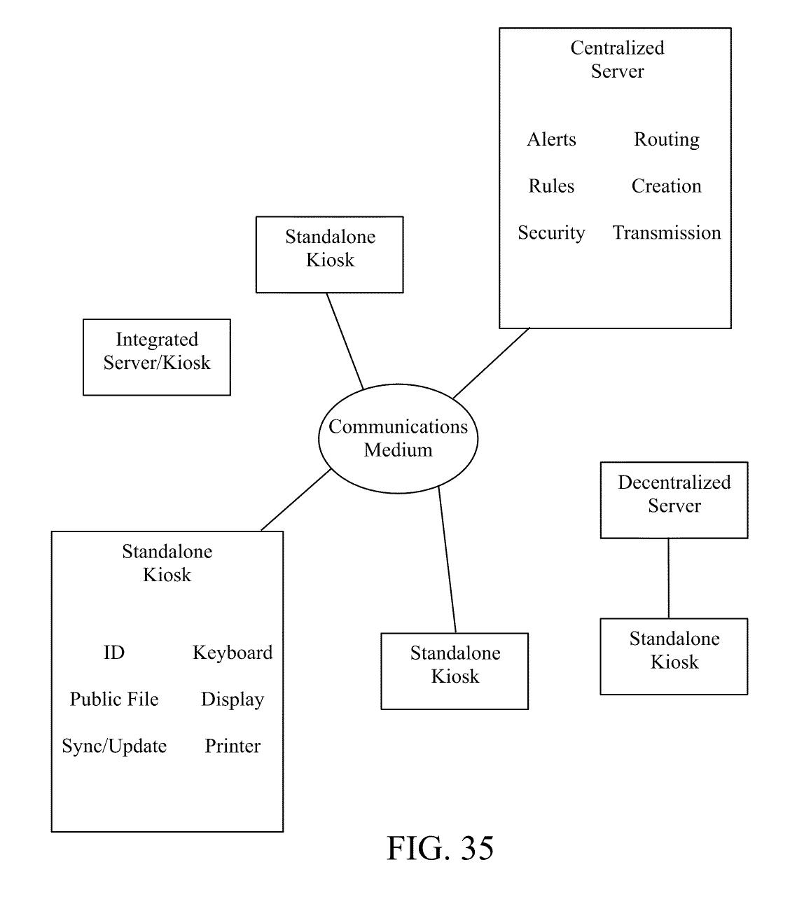

FIG. 35 shows a variety of embodiments for an electronic public inspection file system in accordance with the present invention. The system includes one or more server components which may be implemented as a centralized server, a decentralized server, or an integrated server/kiosk. The server components can include alerts, rules, security, routing, file creation, and transmission. While shown as components of the single centralized server, these components can be spread out among multiple servers. The system further includes multiple workstation kiosks which may be implemented as standalone kiosks connected to the communications medium, standalone kiosks connected directly to the decentralized server, or an integrated server/kiosk. The kiosk components can include the kiosk ID, the Public File, sync/update software, and input/output devices such as a keyboard, display and printer. Two-way communication and feedback between a server and a workstation kiosk can be provided by any convenient communications medium including but not limited to the Internet, wireless (radio or cellular) networks, satellite, public switched telephone network (PSTN), or any combination of the foregoing, including some form of direct wiring. The integrated server/kiosk is a single computer system having both the server and kiosk functionalities as described herein.

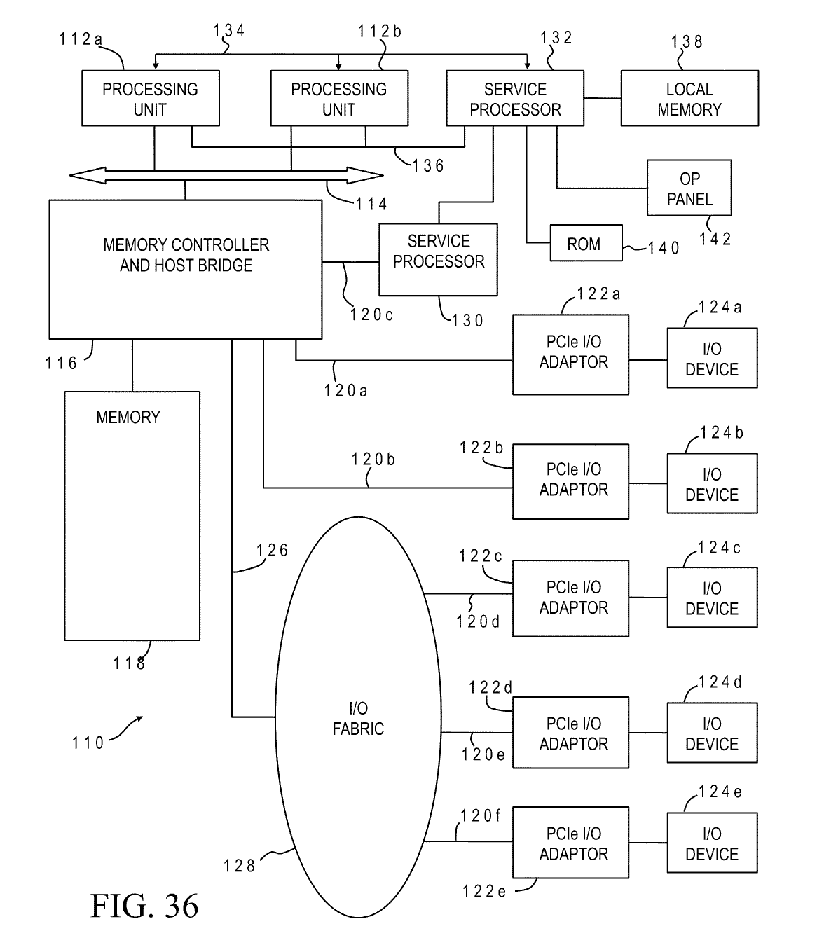

With reference now to FIG. 36, there is depicted one embodiment 110 of a computer system in which the present invention may be implemented to carry out electronic Public File inspection. Computer system 110 is a symmetric multiprocessor (SMP) system having a plurality of processors 112a, 112b connected to a system bus 114. System bus 114 is further connected to a combined memory controller/host bridge (MC/HB) 116 which provides an interface to system memory 118. System memory 118 may be a local memory device or alternatively may include a plurality of distributed memory devices, preferably dynamic random-access memory (DRAM). There may be additional structures in the memory hierarchy which are not depicted, such as on-board (L1) and second-level (L2) or third-level (L3) caches.

MC/HB 116 also has an interface to peripheral component interconnect (PCI) Express links 120a, 120b, 120c. Each PCI Express (PCIe) link 120a, 120b is connected to a respective PCIe adaptor 122a, 122b, and each PCIe adaptor 122a, 122b is connected to a respective input/output (I/O) device 124a, 124b. MC/HB 116 may additionally have an interface to an I/O bus 126 which is connected to a switch (I/O fabric) 128. Switch 128 provides a fan-out for the I/O bus to a plurality of PCI links 120d, 120e, 120f. These PCI links are connected to more PCIe adaptors 122c, 122d, 122e which in turn support more I/O devices 124c, 124d, 124e. The I/O devices may include, without limitation, a keyboard, a graphical pointing device (mouse), a microphone, a display device, speakers, a permanent storage device (hard disk drive) or an array of such storage devices, an optical disk drive, and a network card. Each PCIe adaptor provides an interface between the PCI link and the respective I/O device. MC/HB 116 provides a low latency path through which processors 112a, 112b may access PCI devices mapped anywhere within bus memory or I/O address spaces to receive inputs or transmit outputs. MC/HB 116 further provides a high bandwidth path to allow the PCI devices to access memory 118. Switch 128 may provide peer-to-peer communications between different endpoints and this data traffic does not need to be forwarded to MC/HB 116 if it does not involve cache-coherent memory transfers. Switch 128 is shown as a separate logical component but it could be integrated into MC/HB 116.

In this embodiment, PCI link 120c connects MC/HB 116 to a service processor interface 130 to allow communications between I/O device 124a and a service processor 132. Service processor 132 is connected to processors 112a, 112b via a JTAG interface 134, and uses an attention line 136 which interrupts the operation of processors 112a, 112b. Service processor 132 may have its own local memory 138, and is connected to read-only memory (ROM) 140 which stores various program instructions for system startup. Service processor 132 may also have access to a hardware operator panel 142 to provide system status and diagnostic information.

In alternative embodiments computer system 110 may include modifications of these hardware components or their interconnections, or additional components, so the depicted example should not be construed as implying any architectural limitations with respect to the present invention.

When computer system 110 is initially powered up, service processor 132 uses JTAG interface 134 to interrogate the system (host) processors 112a, 112b and MC/HB 116. After completing the interrogation, service processor 132 acquires an inventory and topology for computer system 110. Service processor 132 then executes various tests such as built-in-self-tests (BISTs), basic assurance tests (BATs), and memory tests on the components of computer system 110. Any error information for failures detected during the testing is reported by service processor 132 to operator panel 142. If a valid configuration of system resources is still possible after taking out any components found to be faulty during the testing then computer system 110 is allowed to proceed. Executable code is loaded into memory 118 and service processor 132 releases host processors 112a, 112b for execution of the program code, e.g., an operating system (OS) which is used to launch applications and in particular the e-PIF application of the present invention, results of which may be stored in a hard disk drive of the system (an I/O device 124). While host processors 112a, 112b are executing program code, service processor 132 may enter a mode of monitoring and reporting any operating parameters or errors, such as the cooling fan speed and operation, thermal sensors, power supply regulators, and recoverable and non-recoverable errors reported by any of processors 112a, 112b, memory 118, and MC/HB 116. Service processor 132 may take further action based on the type of errors or defined thresholds.

While the illustrative implementation provides program instructions embodying the present invention on a disk drive of computer system 110, those skilled in the art will appreciate that the invention can be embodied in a program product utilizing other computer-readable storage media. The program instructions may be written in the C++ programming language for an AIX, Linux or Windows 7 environment or in other programming languages suitable for other operating system platforms. Computer system 110 may include conventional aspects of various document viewing and editing tools, and these details will become apparent to those skilled in the art upon reference to this disclosure.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A kiosk for accessing public inspection files of a media outlet, comprising:
one or more processors which process program instructions;
a memory connected to said one or more processors;
an input device connected to said one or more processors;
an output device connected to said one or more processors; and
program instructions residing in said memory for receiving media outlet public inspection file information from a server, storing the media outlet public inspection file information in said memory, and transmitting one or more selected portions of the media outlet public inspection file information to said output device in response to user control of said input device.

2. The kiosk of claim 1 wherein the output device is a display device, and the selected portions of the media outlet public inspection file information are filenames for documents in a selected category.

3. The kiosk of claim 1 wherein said program instructions further include instructions for sending a unique kiosk identifier to the server which distinguishes the kiosk from other kiosks.

4. The kiosk of claim 1 wherein said program instructions further include instructions for comparing a current date to an expiration date of a document in the media outlet public inspection file information to determine if the document has expired, and for removing the document from the selection portions transmitted to the output device when the document has expired.

5. The kiosk of claim 1 wherein said program instructions further include instructions for periodically synchronizing the media outlet public inspection file information with the server.

6. The kiosk of claim 1 wherein said program instructions further include instructions for assigning different security levels to different kiosk users which allow different access rights to documents in the media outlet public inspection file information depending upon a security level of the document.

7. A server for managing public inspection files of a media outlet, comprising:
one or more processors which process program instructions;
a memory connected to said one or more processors; and
program instructions residing in said memory for determining that a particular document stored in said memory impacts at least one media outlet in regard to public inspection file compliance based on business rules and, in response thereto, automatically transmitting the particular document to a kiosk workstation associated with the media outlet.

8. The server of claim 7 wherein said program instructions further include instructions for sending an electronic message to at least one user with a deadline pertaining to the particular document.

9. The server of claim 7 wherein said program instructions further include instructions for creating a plurality of document categories and assigning one of the categories to the particular document.

10. The server of claim 9 wherein said program instructions further include instructions for sending an electronic message to at least one user with a notification regarding the particular document based on the category assigned to the particular document.

11. The server of claim 7 wherein said program instructions determine that the particular document impacts a plurality of media outlets and, in response thereto, automatically transmit the particular document to a plurality of kiosk workstations respectively associated with the media outlets using unique identifiers assigned to the kiosk workstations.

12. The server of claim 11 wherein said program instructions determine that the particular document impacts the plurality of media outlets based on a selected combination of media markets, media stations, and media licensees.

13. An electronic public inspection file system comprising:
a plurality of kiosks at different locations of media stations each assigned a unique kiosk identifier, a given kiosk having an electronic public inspection file containing enterprise documents relating to the media station at the location of said given kiosk, and having a display device for viewing the electronic public inspection file; and
at least one server remote from said kiosks which determines that a newly-created document impacts a subset of the media stations and, in response thereto, automatically transmits the newly-created document to a corresponding subset of said kiosks using the unique kiosk identifiers.

14. The electronic public inspection file system of claim 13 wherein said kiosks compare a current date to an expiration date of an older document in its electronic public inspection file to determine if the older document has expired, and removes the older document from any display of the electronic public inspection file when the older document has expired.

15. The electronic public inspection file system of claim 13 wherein said kiosk periodically synchronizes the electronic public inspection file with said server.

16. The electronic public inspection file system of claim 13 wherein said kiosk assigns different security levels to different kiosk users which allow different access rights to different documents in the electronic public inspection file depending upon security levels of the different documents.

17. The electronic public inspection file system of claim 13 wherein said server sends an electronic message to at least one user with a deadline pertaining to the newly-created document.

18. The electronic public inspection file system of claim 13 wherein said server determines that the newly-created document impacts the subset of the media stations based on a selected combination of media markets, media stations, and media licensees.

19. The electronic public inspection file system of claim 13 wherein said server assigns one of a plurality of document categories to the newly-created document.

20. The electronic public inspection file system of claim 19 wherein said server sends an electronic message to at least one user with a notification regarding the newly-created document based on the category assigned to the newly-created document.
